(19) United States
(12) Patent Application Publication
(10) Pub. No.: US 2009/0043718 A1
(43) Pub. Date: Feb. 12, 2009

(54) Evolutionary hypernetwork classifiers for microarray data analysis

(75) Inventors: Byoung-Tak Zhang, Seoul (KR); Sun Kim, Seoul (KR); Soo-Jin Kim, Gyunggi (KR)

Correspondence Address: HARNESS, DICKEY & PIERCE, P.L.C., P.O. BOX 828, BLOOMFIELD HILLS, MI, 48303, US

(73) Assignee: Seoul National University Industry Foundation

(21) Appl. No.: 11/890,453

(22) Filed: Aug. 6, 2007

(51) Int. Cl. G06N 3/12

(52) U.S. Cl. 706/13

(57) ABSTRACT

The present invention is to identify the gene modules associated with cancers from microarray data using the evolved hypernetwork classifier.

### BACKGROUND

1. Field of the invention

The present invention relates to hypernetworks, a random hypergraph model with weighted edges. The present invention relates to identify the gene modules associated with cancers from microarray data.

2. Description of the Related Art

High-throughput gene expression profiling has been used as one of the most important and powerful approaches in biomedical research [1. S. Ramaswamy and T. R. Golub, DNA microarrays in clinical oncology, Journal of Clinical Oncology, 20, pp. 1932-1941, 2002.], [2. M. Schena, D. Shalon, R. W. Davis, and P. O. Brown, Quantitative monitoring of gene expression patterns with a complementary DNA microarray, Science, 270, pp. 467-470, 1995.], [3. D. J. Lockhart, H. Dong, M. C. Byrne, M. T. Follettie, M. V. Gallo, M. S. Chee, M. Mittmann, C. Wang, M. Kobayashi, H. Norton, and E. L. Brown, Expression monitoring by hybridization to high-density oligonucleotide arrays, Nature Biotechnology, 14, pp. 1675-1680, 1996.].

While traditional methods only allow one or a few genes to be examined at once, the microarray techniques measure the expression level of thousands of genes or potentially the whole-genome scale simultaneously. This has allowed to make a systemic analysis of the particular disease mechanism such as cancers at the molecular level. Recently, the analysis of gene expression data at the level of biological modules, rather than individual genes, is recognized as important for understanding the cancer regulatory mechanisms [4. E. Segal, N. Friedman, N. Kaminski, A. Regev, and D. Koller, From signatures to models: understanding cancer using microarrays, Nature Genetics, 37, s38-s45, 2005.].

This analysis has a biologically important meaning that the joint regulation genes can detect significant expression changes even in the case where the expression of individual genes is not meaningful. However, it is difficult to infer cancer-related pathways by inducing modules of co-regulated genes [5. E. Segal, N. Friedman, D. Koller, and A. Regev, A module map showing conditional activity of expression modules in cancer, Nature Genetics, 36, pp. 1090-1098, 2004.].

Finding cancer-related genes from the microarray analysis is typically based on the correlations between each gene and particular samples. The highly correlated genes have properties that their expression patterns are separated into two distinct parts corresponding to cancer and normal tissues, hence it became a popular method to find peculiar expression patterns between different types of diseases. Nevertheless, they can be inappropriate for systemic analysis because they do not identify synergistically interacting genes.

Recently, machine learning methods have been successfully used in microarray data analysis, and most of them use large margin classification techniques such as support vector machines (SVMs) [6. M. P. S. Brown, W. N. Grundy, D. Lin, N. Cristianini, C. W. Sugnet, T. S. Furey, M. Ares, Jr., and D. Haussler, Knowledge-based analysis of microarray gene expression data by using support vector machines, Proceedings of the National Academy of Sciences, 97(1), pp. 262-267, 2000.], [7. I. Guyon, J. Weston, S. Barnhill, and V. Vapnik, Gene selection for cancer classification using support vector machines, Machine Learning, 46, pp. 389-422, 2002.] and boosting [8. M. Dettling and P. Buhlmann, Boosting for tumor classification with gene expression data, Bioinformatics, 19, pp. 1061-1069, 2003.], [9. P. M. Long, V. B. Vega, Boosting and microarray data, Machine Learning, 52, pp. 31-44, 2003.]. The margin serves as a decision boundary separating gene expression patterns into classes of samples (or tissues). However, the performance of such methods is limited to identify the optimum solutions in the nonlinear classification problems. Furthermore, the relationship among selected genes cannot be easily explained, as well as their combined role is not interpretable. To address such problems, several efforts have been made to analyze gene expression data at the level of biological modules, rather than individual genes [10. A. Subramanian, P. Tamayo, V. K. Mootha, S. Mukherjee, B. L. Ebert, M. A. Gillette, A. Paulovich, S. L. Pomeroy, T. R. Golub, E. S. Lander, and J. P. Mesirov, Gene set enrichment analysis: A knowledge-based approach for interpreting genome-wide expression profiles, Proceedings of the National Academy of Sciences, 102, pp. 15545-15550, 2005.], [11. J. Lamb, S. Ramaswamy, H. L. Ford, B. Contreras, R. V. Martinez, F. S. Kittrell, C. A. Zahnow, N. Patterson, T. R. Golub, and M. E. Ewen, A mechanism of cyclin D1 action encoded in the patterns of gene expression in human cancer, Cell, 114, pp. 323-334, 2003.], [12. D. R. Rhodes, J. Yu, K. Shanker, N. Deshpande, R. Varambally, D. Ghosh, T. Barrette, A. Pandey, and A. M. Chinnaiyan, Largescale meta-analysis of cancer microarray data identifies common transcriptional profiles of neoplastic transformation and progression, Proceedings of the National Academy of Sciences, 101, pp. 9309-9314, 2004.], [13. E. Huang, S. Ishida, J. Pittman, H. Dressman, A. Bild, M. Kloos, M. D'Amico, R. G. Pestell, M. West, and J. R. Nevins, Gene expression phenotypic models that predict the activity of oncogenic pathways, Nature Genetics, 34, pp. 226-230, 2003.]. However, inferring modules of multiple coregulated genes directly from the microarray data remains a difficult problem.

### SUMMARY

Accordingly, the present invention has been made to solve the above-mentioned problems occurring in the prior art, and an object of the present invention is to identify the gene modules associated with cancers from microarray data.

Additional advantages, objects and features of the invention will be set forth in part in the description which follows and in part will become apparent to those having ordinary skill in the art upon examination of the following or may be learned from practice of the invention.

In an aspect of the present invention, there is provided a method for identifying gene modules from microarray data using the hypernetwork including vertices and weighted hyperedges, comprising: building the hypernetwork classifier from microarray data using a random hypernetwork process; performing evolution of the hypernetwork as generation goes on; and using the evolved hypernetwork classifier for microarray data analysis to discover biologically significant gene modules.

The procedure for building the hypernetwork classifier may comprise: starting with the empty hypernetwork H′=(X′,E′,W′)=(Ø,Ø,Ø); getting a training sample x with the probability p and generating the hypernetwork H′=(X′,E′,W′), which includes hyperedges (individuals), Eᵢ, of cardinality k from x by a random hypergraph process; being H←H∪H′; and going to the getting step unless the termination condition is met.

The evolutionary algorithm to adjust the weights of the hyperedges in hypernetwork classifier may comprise: getting a training example (x, y), after generating a population by the random hypernetwork process; evaluating the fitness by classifying x, which let this class bey*; updating the population if y*≠y, which c_{Ei←c}_{Ei}+Δc_{Ei}, where c_{Ei} is the number of individuals corresponding the hyperedge Eᵢ∈E(x, y) and normalizes the duplicates of all individuals in the current population; and going to the getting step unless the termination condition is met.

The microarray data is microRNA (miRNA) expression data. The method may further comprise: finding the functional correlations among miRNA target genes by extracting the gene ontology terms, to examine the discovered miRNAs.

In another aspect, the gene modules may be associated with cancer when the microarray includes cancer-related samples. The hypernetwork may be the 2-uniform hypernetwork to classify the miRNA expression data. The microarray data may be used as the form of a set of data (x, y), where x=(x₁, x₂, . . . , xₙ)∈{0, 1}ⁿ and y∈{0, 1}. Individuals of the hypernetwork classifier may be selected from the training samples with the probability p=0.5.

A sigmoid function may be using as the energy function of the hypernetwork classifier.

### BRIEF DESCRIPTION OF THE DRAWINGS

The above and other objects, features and advantages of the present invention will be more apparent from the following detailed description taken in conjunction with the accompanying drawings, in which:

FIG. 1 is an example hypergraph consisting of seven vertices and five hyperedges of variable cardinality;

FIG. 2 is an example of transforming hyperedges to individuals to be evolved by an evolutionary learning algorithm. An individual consists of a set of vertices and a label, which indicates a hyperedge;

FIG. 3 is the procedure for building an initial population;

FIG. 4 is the evolutionary algorithm to adjust the weights of hyperedges in hypernetwork classifiers;

FIG. 5 compares the output functions for the hyperedges of different potential functions.

FIG. 6 is the procedure for building a hypernetwork classifier from miRNA expression dataset. The hypernetwork is represented as a collection of hyperedges which are then encoded as a population for evolutionary learning. A population represents the hypernetwork, where the weights of hyperedges are encoded as the number of duplicates of the individuals; and

FIG. 7 is performance evolution of the population representing the hypernetwork for the miRNA expression dataset. Shown are the average classification rates of leave-one-out cross validation.

### DETAILED DESCRIPTION

The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

Hereinafter, embodiments of the present invention will be described in detail with reference to the accompanying drawings.

High-throughput microarrays inform us on different outlooks of the molecular mechanisms underlying the function of cells and organisms. While computational analysis for the microarrays show good performance, it is still difficult to infer modules of multiple co-regulated genes. Here, we present a novel classification method to identify the gene modules associated with cancers from microarray data. The proposed approach is based on ‘hypernetworks’, a hypergraph model consisting of vertices and weighted hyperedges. The hypernetwork model is inspired by biological networks and its learning process is suitable for identifying interacting gene modules. Applied to the analysis of microRNA (miRNA) expression profiles on multiple human cancers, the hypernetwork classifiers identify cancer-related miRNA modules. The results show that our method performs better than decision trees and naive Bayes. The biological meaning of the discovered miRNA modules is examined by literature search.

I. Introduction

In this specification, we propose a novel approach to identify the gene modules associated with cancers from microarray data. The proposed approach is based on hypernetworks [14. B.-T. Zhang and J.-K Kim, DNA hypernetworks for information storage and retrieval, Lecture Notes in Computer Science, DNA12, 4287, pp. 298-307, 2006.], [15. B.-T. Zhang, Random hypergraph models of learning and memory in biomolecular networks: shorter-term adaptability vs. longer-term persistency, The First IEEE Symposium on Foundations of Computational Intelligence, 2007.], a random hypergraph model [16. S. Janson, T. Luczak, and A. Rucinski, Random graphs, Wiley, 2000.] with weighted edges.

The concept of the hypernetworks originated in biomolecular networks which maintain the stability, while rapidly adapting to the cellular environmental changes. This property is useful for analyzing complicated and large-scale biological problems such as cancer regulatory mechanisms. In addition, the hypernetwork classifiers naturally provide understandable causes behind their predictions. In the hypernetwork frameworks, learning is performed by an evolutionary algorithm [17. D. B. Fogel, Evolutionary computation. IEEE Press, 1995.], [18. T. Back, Evolutionary algorithms in theory and practice, Oxford University Press, 1996.] to find the best combinations of higher-order features and their weights.

In experiments, we apply the hypernetwork classifiers to microRNA (miRNA) expression profiles related to human cancers [19. J. Lu, G. Getz, E. A. Miska, E. Alvarez-Saavedra, J. Lamb, D. Peck, A. Sweet-Cordero, B. L. Ebert, R. H. Mak, A. A. Ferrando, J. R. Downing, T. Jacks, H. R. Horvitz, and T. R. Golub, MicroRNA expression profiles classify human cancers, Nature, 435, pp. 834-838, 2005.]. The goal is to identify miRNA pairs, whose expression patterns can predict the presence of cancer with high classification accuracy. Our experimental results show that the hypernetwork classifiers provide a competitive performance to neural networks and support vector machines, and outperform decision trees and naive Bayes. We also examine the relevance of the discovered miRNA modules to causes of cancers.

The specification is organized as follows. In Section 2, the hypernetwork classifiers are explained. Section 3 describes the connection to evolutionary computation and evolutionary learning procedure. In Section 4, the experimental results on miRNA expression profiles are provided. Concluding remarks and directions for further research are given in Section 5.

II. Hypernetwork Classifiers

Hypernetworks are a graphical model which is naturally implemented as a library of interacting DNA molecular structures. Here, we briefly introduce the hypernetwork classifiers.

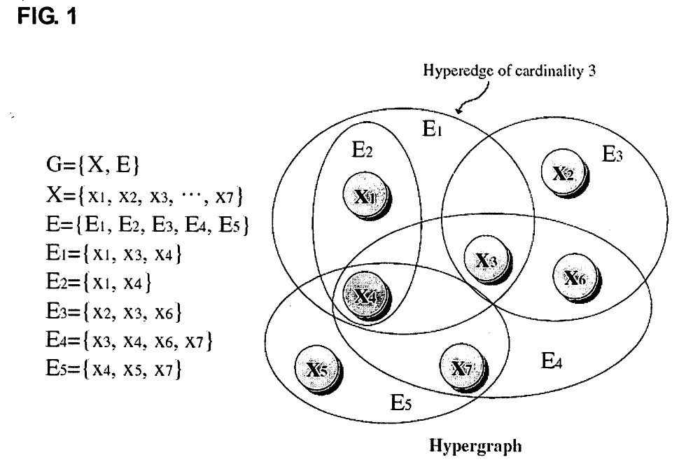

A hypergraph is an undirected graph G whose edges connect a non-null number of vertices [20. C. Berge, Graphs and hypergraphs, North-Holland Publishing, Amsterdam, 1973.], i.e., G={X,E}, where X={X₁,X₂ . . . ,Xₙ}, E={E₁,E₂ . . . ,Eₘ}, and Eᵢ={xᵢ₁, xᵢ₂, . . . , xᵢₖ}. Eᵢ is called the hyperedges. Mathematically, Eᵢ is a set and its cardinality (size) is k≧1, i.e., the hyperedges can connect more than two vertices while in ordinary graphs the edges connect maximum two vertices, i.e., k≦2. A hyperedge of cardinality k will be referred to as a k-hyperedge. The use of these hyperedges allows for additional degrees of freedom in representing a network while preserving the mathematical methods provided by the graph theory. FIG. 1 shows a hypergraph consisting of seven vertices X={X₁,X₂. . . , X₇} and five hyperedges E={E₁,E₂ . . . ,E₅} each having a different cardinality.

Hypernetworks are a generalization of the hypergraphs by assigning weights to its hyperedges, so that it can represent how strong vertex sets are attached. Formally, we define a hypernetwork as a triple H=(X,E,W), where X={X₁,X₂ . . . ,Xₙ}, E={E₁,E₂ . . . , Eₘ}, W={w₁, w₂ . . . , wₘ}. A k-hypernetwork consists of a set of X of vertices, a subset of E of X[k], and a set W of hyperedge weights, where E=X[k] is a set of subsets of X whose elements have precisely k members. A hypernetwork H is said to be k-uniform if every edge Eᵢ in E has cardinality k.

From the aspect of biological network, the hyperedges in a hypernetwork can be viewed as building blocks, such as modules, motifs, and circuits [21. R. Milo, S. Shen-Orr, S. Itzkovitz, N. Kashitan, D. Chklovskii, and U. Alon, Network motifs: simple building blocks of comples networks, Science, 298, pp. 824-827, 2002.], [22. D. M. Wolf and A. P. Arkin, Motifs, modules and game in bacteria, Current Opinion Microbiology, 6(2), pp. 125-134, 2003.]. Particularly, it is a significant discovery when the hyperedges are of large weights in the biological problem. In this sense, the hypernetwork structure can be used to identify massively interacting biological modules.

A learning task can be regarded as storing a data set D at a model, so that the stored data can be retrieved later by an example. Formally, a hypernetwork can be used as a probabilistic memory. Let ε(x⁽ⁿ⁾; W) be the energy of the hypernetwork, where x⁽ⁿ⁾∈D denotes the n-th data to store and W represents the parameters (hyperedge weights) for the hypernetwork model. Then, the probability of the data being generated from the hypernetwork is given as Gibbs distribution

$$P ( {x}^{( n )} \vert w ) = \frac{1}{Z ( W )} exp \{ - ɛ ( {x}^{( n )} ; W ) \} , \qquad ( 1 )$$

where exp{−ε(x⁽ⁿ⁾; W)} is the Boltzmann factor and Z(W) is the normalizing term.

In classification tasks, a data consists of a set of features xᵢ and a label y, i.e. (x, y)∈D. Here, the hypernetwork classifiers can be represented by adding a vertex y to the set of vertices X. At this point, we can formulate the joint probability P(x, y) as

$$P ( x , y ) = \frac{1}{Z ( W )} exp \{ - ɛ ( x , y ; W ) \} . \qquad ( 2 )$$

Given input x, the classifier returns its class by computing the probability of each class conditional, and then determining the class whose conditional probability is the highest, i.e.

$$\begin{matrix}{y}^{*} = arg {max}_{y} P ( y \vert x ) & ( 3 ) \\ = arg {max}_{y} \frac{P ( x , y )}{P ( x )} , & ( 4 )\end{matrix}$$

where P(x, y)=P(y|x)P(x) and y represents the candidate classes. Since P(x) can be omitted in the discriminative model, Equation (4) is rewritten as follows:

$$\begin{matrix}{y}^{*} = arg {max}_{y} \frac{P ( x , y )}{P ( x )} = arg {max}_{y} P ( x , y ) & ( 5 ) \\ = arg {max}_{y} \frac{1}{Z ( w )} exp \{ - ɛ ( x ; W ) \} & ( 6 ) \\ = arg {max}_{y} exp \{ - ɛ ( x ; W ) \} & ( 7 ) \\ = arg {max}_{y} - ɛ ( x ; W ) & ( 8 ) \\ = arg {min}_{y} ɛ ( x ; W ) . & ( 9 )\end{matrix}$$

The energy function ε(x; W) can be expressed in many ways such as linear functions, sigmoid functions, and Gaussian functions. In effect, a hypernetwork represents a probabilistic model of a data set using a population of hyperedges and their weights.

III. Evolutionary Learning for Hypernetwork Classifiers

The hypernetwork classifiers are to choose a label y to minimize the energy function ε, and the learning task is to adjust the weights of hyperedges to fit in with training data. We now introduce an evolutionary learning method to find the optimal hypernetworks that maximize classification accuracy.

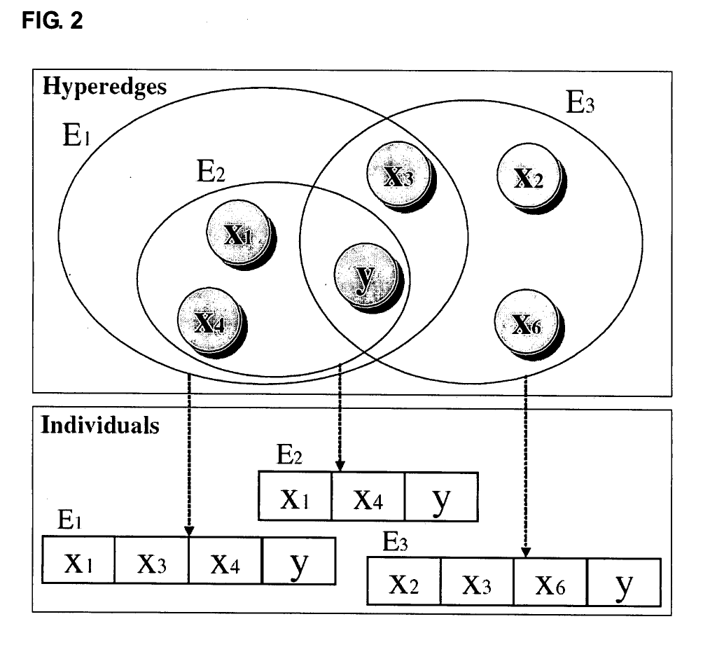

For evolving the hypernetworks, we assume that a population represents a hypernetwork classifier, and its individuals represent hyperedges. We express the weight of a hyperedge by allowing duplicates of an individual in the population. The learning task of a hypernetwork is now changed to adjust the number of individuals towards minimizing the classification errors. FIG. 2 shows an example of the individuals. Note that a hyperedge consists of a set of vertices and a label in supervised learning problems.

To make an initial population, i.e. a hypernetwork classifier, we use a random graph model, which is a graph constructed by a random procedure [15], [16]. For a k-hypergraph, the number of possible hyperedges are

$$\vert E \vert = C ( n , k ) = \frac{n !}{k ! ( n - k ) !} , \qquad ( 10 )$$

where n=|X|. If we denote the set of all graphs as Q, its size is

|Ω|=2^{C(n,k)}. (11)

However, |Ω| rapidly increases when k and ii becomes large, which is common in real-world problems. Hence, we use a stochastic approach based on the random graphs to solve this combinatorial explosion. A hypernetwork generated from the random graph process is called a random hypernetwork. A random graph model chooses a graph at random, with equal probabilities, from the set of all possible graphs. We consider a probability space

(Ω, [symbol] ), (12)

where Ω is the set of all graphs, F is the family of all subsets of Ω, and to every ω∈Ω we assign its probability as

[symbol]

(ω)=2^{-C(n,k)}. (13)

The probability space can be viewed as the product of C(n, k) binary spaces. It is a result of C(n, k) independent tosses of a fair coin, i.e. Bernoulli experiments.

The random hypernetworks can be generated by a binomial random graph process. Given a real number p, 0≦p≦1, the binomial random graph G(n, p) is defined by taking as Ω and setting

P( [symbol] )=p^{|E(} [symbol] ^{)|}(1−p)^{C(n,k)-|E(} [symbol] ^{)|}, (14)

where |E(G)| stands for the number of edges of G. The random hypernetworks are generated by repeating the random hypergraph process.

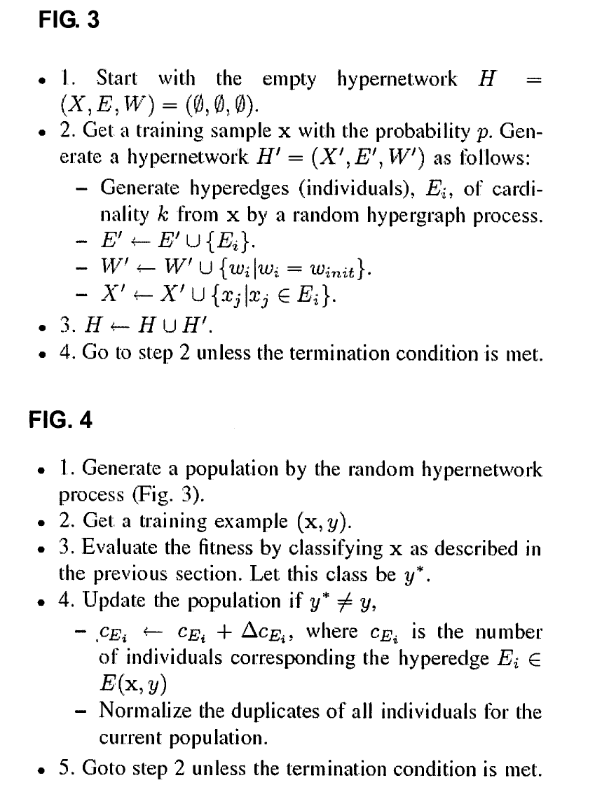

FIG. 3 denotes the procedure for building an initial population based on the random hypergraph process. Starting with the empty hypernetwork, new hypernetwork H′ is repeatedly generated from a training sample x with the probability p.

Alternatively, a random H′ (not from x) can be generated with the probability (1−p). This alternate case helps to give a diversity in the population. For every H′, the duplicates of the hyperedge Eᵢ are added to the initial population, where the number of duplicates is wᵢₙᵢₜ. The procedure is terminated if the population reaches a predefined size m. The random hypernetwork results in reducing the population size, while maintaining its classification performance.

FIG. 4 presents the evolutionary algorithm to adjust the number of individuals of the population. We start with a random hypernetwork. As a new training example (x, y) is observed, the population is evaluated by classifying x. The class y* of x is determined by the classification procedure described in the previous section. If the label y* is correct, no action is performed because the current population correctly classifies the example. If the label y* is incorrect, the population is modified by adding a number of hyperedges, Δc_{Ei}, where Eᵢ∈E(x,y).

It is interesting that the evolutionary learning performs gradient search to find an optimal hypernetwork for the training examples. Given x and y, where x=(x₁, x₂, . . . , xₙ)∈{0, 1}ⁿ and y∈{0, 1}, let us assume that the energy function ε(x⁽ⁿ⁾; W) is a sigmoid function.

$$\begin{matrix}ɛ ( x ; W ) = \frac{1}{1 + exp ( - f ( x , W ) )} , & ( 15 ) \\ where & \\ f ( x , W ) = {\sum }_{i = 1}^{\vert E \vert} {w}_{{i}_{1} {i}_{2 } … {i}_{\vert {E}_{i} \vert}} {x}_{{i}_{1}} {x}_{{i}_{2}} … {x}_{{i}_{\vert {E}_{i} \vert}} . & ( 16 )\end{matrix}$$

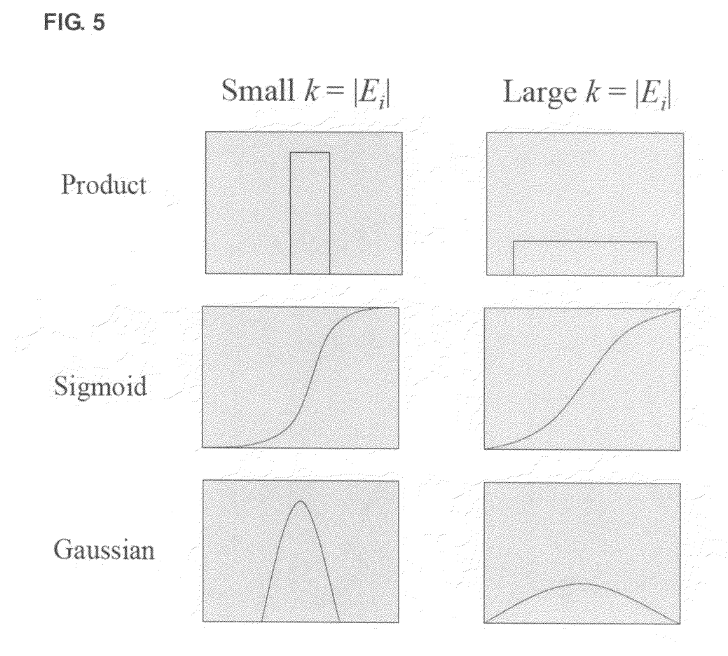

FIG. 5 compares the output functions for the hyperedges of different potential functions. Also shown is the effect of the size of hyperedges. When the hyperedges are small, i.e. for small k=|Eᵢ|, the receptive fields are narrow and thus the hypernetwork builds a representation consisting of low-dimensional, general components (micromodules). When the hyperedges are large, the hypernetwork builds a representation consisting of high-dimensional, specialized components. To see the profile of distribution we consider the histogram of k-hyperedges within a hypernetwork.

Referring to FIG.5, it shows three examples of potential (basis) functions to be associated with the hyperedges. The potential functions with small k-hyperedges receive inputs from a narrow range (in dimensions) while those with large k-hyperedges observe a wide range of the input space. Thus, changing the parameter k in the random hypernetworks has an effect of varying the receptive-field size in neural networks.

Note that xᵢ₁, xᵢ₂ . . . x_{i|Ei|} is a combination of k elements of the data x which is represented as a k-hyperedge in the network. We can then write down the error function

$$G ( W ) = - {\sum }_{n = 1}^{N} ( {y}^{( n )} ln ɛ ( {x}^{( n )} ; W ) + ( 1 - {y}^{( n )} ) ln ( 1 - ɛ ( {x}^{( n )} ; W ) ) ) . \qquad ( 17 )$$

Here, the derivative g=∂G/∂W is given by

$${g}_{i} = \frac{\partial G}{\partial {w}_{i}} = {\sum }_{n = 1}^{N} - ( {y}^{( n )} - {y}^{* ( n )} ) {x}^{( n )} . \qquad ( 18 )$$

Since the derivative ∂G/∂W is a sum of g⁽ⁿ⁾, we can obtain an online algorithm by putting each input at a time, and adjusting W in a direction opposite to g⁽ⁿ⁾. (y⁽ⁿ⁾−y*⁽ⁿ⁾) is the error on an example, and W is changed only if the classifier is incorrect. According to Equation (18), we show that the evolutionary algorithm in FIG. 4 is a simplified version of the on-line gradient search. More details related to the derivation can be found in [23. S. Kim, M.-O. Heo, and B.-T. Zhang, Text classifiers evolved on a simulated DNA computer, IEEE Congress on Evolutionary Computation, pp. 9196-9202, 2006.].

IV. Experimental Results

For experiments, we perform the miRNA expression classification using the microarray dataset in [19]. It includes the expression profiles of 151 miRNAs on 89 samples, which consists of 68 multiple human cancer tissues and 21 normal tissues. We use a set of data (x, y), where x=(x₁, x₂, . . . xₙ)∈{0, 1}ⁿ and y∈{0, 1}. i.e. a binary dataset. Although the hypernetwork classifiers can accept any attribute such as integers or real numbers, the discretized expression data provides flexibility for extending to molecular computation [14]. Moreover, the hypernetwork classifiers are easily implemented in silico with binary numbers. Hence, we divide the expression levels of the miRNA data into binary numbers based on medians on each sample.

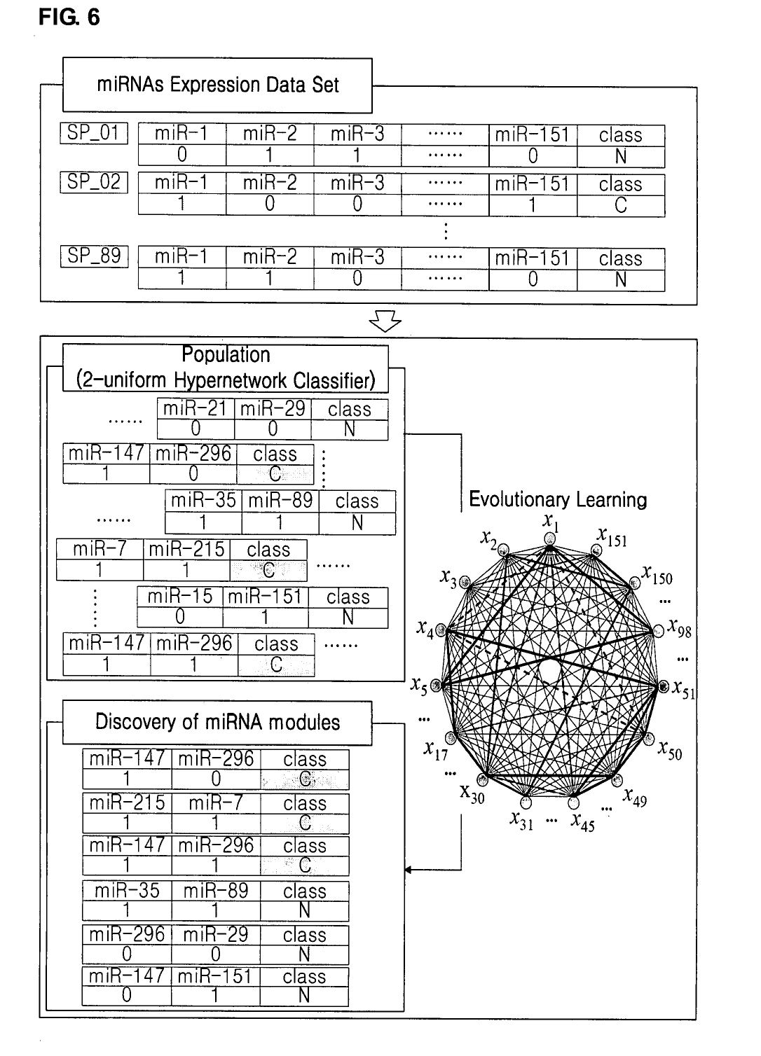

FIG. 6 presents the whole procedure for building a hypernetwork classifier, i.e. a population. We use a 2-uniform hypernetwork to classify the miRNA expression profiles.

The initial population is generated using the random hypernetwork process. The individuals are selected from the training examples with the probability p=0.5. Unless the training examples are selected, the individuals are sampled from random examples. The individuals are set to 50,000, and the number of duplicates is initialized to 1,000. We use a signoid function as the energy function ε(x; W) of the hypernetwork classifier.

Setting the learning parameter η=Δc_{Ei}/c_{Ei} in FIG. 4 is important to balance the adaptability and stability of the population. The larger η is, the larger gets the distribution changes of the population. In the experiments, learning parameter η is started from 0.01, and decreased to η=0.75×η when the whole accuracy of current epoch drops compared than that of previous epoch. The learning procedure is stopped after 40 epochs.

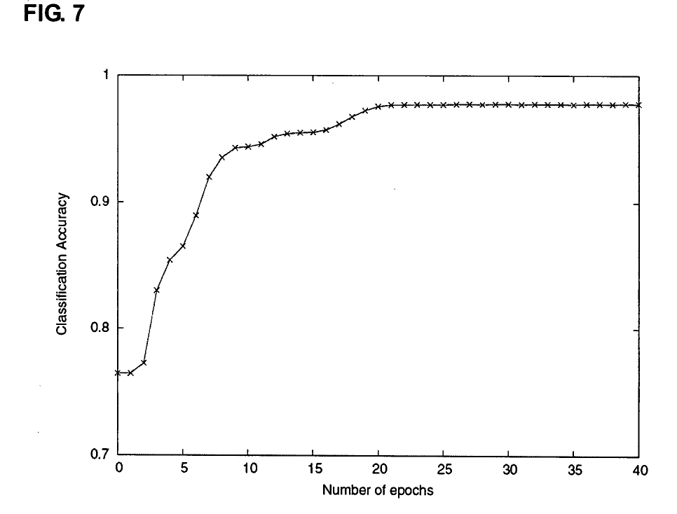

FIG. 7 depicts the performance evolution of the population as generation goes on. Since the evolution progresses in on-line manner, we present the performance evolution by taking the classification accuracy at each epoch. Note that the actual fitness is measured every time a training example is observed. The performance curves are increased gradually, and stabilized after 20th epoch. The early generations are the process to explore candidate hypernetworks for better miRNA classification. As the generation progresses further, the increment of the performance falls down because the population is converged to the optimal hypernetwork.

A. miRNA Expression Classification

Table I presents the performance comparison of the hypernetworks and other machine learning methods, backpropagation neural networks (BPNNs), support vector machines (SVMs), decision trees, and naive Bayes. Using leave-one-out cross validation, the hypernetwork classifier shows 91.46% of accuracy. It is better than decision trees and naive Bayes, while providing competitive performance to the SVM or BPNNs. Compared to the SVM or BPNNs, the hypernetwork classifiers feature the ability of analyzing significant gene modules.

TABLE I
PERFORMANCE COMPARISON OF THE HYPERNETWORKS AND
CONVENTIONAL ALGORITHMS FOR THE miRNA EXPRESSION
DATASET

| Algorithms | Accuracy (%) |
|---|---|
| Backpropagation Neural Networks | 92.13 |
| Hypernetworks | 91.46 |
| Support Vector Machines | 91.01 |
| Decision Trees | 88.76 |
| Naive Bayes | 83.14 |

As mentioned before, the hypernetwork classifiers can be used in molecular computation, which allows huge population size. Therefore, higher-order hypernetwork classifiers can be implemented by the molecular computing for better classification performance and analysis of more sophisticated gene interactions.

B. miRNA Module Discovery

The hypernetwork classifiers naturally can be used for microarray analysis to discover significant gene modules. Table II shows the high-ranked miRNA modules among ten experiments.

hsa-miR-147 is located near (<2 Mb) to the markers with the highest rate of LOH (loss of heterozygosity) [25. G. A. Calin, C. Sevignani, C. D. Dumitru, T. Hyslop, E. Noch, S. Yendamuri, M. Shimizu, S. Rattan, F. Bullrich, M. Negrini, and C. M. Croce, Human microRNA genes are frequently located at fragile sites and genomic regions involved in cancers, Proceedings of the National Academy of Sciences, 101(9), pp. 2999-3004, 2006.]. The LOH is a major mechanism in the genomic alteration that transforms a normal cell into an unregulated tumor cell.

hsa-miR-215 is located in the region with DNA copy number gains in ovarian and breast cancers [24. L. Zhang, J. Huang, N. Yang, J. Greshock, M. S. Megraw, A. Giannakakis, S. Liang, T. L. Naylor, A. Barchetti, M. R. Ward, G. Yao, A. Medina, A. O. Brien-Jenkins, D. Katsaros, A. Hatzigeorgiou, P. A. Gimotty, B. L. Weber, and G. Coukos, MicroRNAs exhibit high frequency genomic alterations in human cancer, Proceedings of the National Academy of Sciences, 103, pp. 9136-9141, 2006.]. It is because DNA copy number alterations may be a critical factor affecting expression of miRNAs in cancers.

hsa-miR-23b is located in one of two regions on 9q, where genomic deletion is found [25]. It is known that there is the genomic alteration in a human cancer.

TABLE II
HIGH-RANKED miRNA MODULES RELATED TO CANCERS
miRNA modules

| a | b |
|---|---|
| hsa-miR-147 | hsa-miR-296 |
| hsa-miR-215 | hsa-miR-7 |
| hsa-miR-130b | hsa-miR-23b |
| hsa-miR-105 | hsa-miR-133a |
| hsa-miR-147 | hsa-miR-206 |

To examine the discovered miRNA modules, we find the functional correlations between target mRNAs by extracting the gene ontology (GO) terms. The GO has become a standard to validate the functional coherence of genes. This project aims to develop three structured, controlled vocabularies that describe gene products in terms of their associated biological processes (BP), cellular components (CC), and molecular functions (MF) in a species-independent manner.

Typically, the validation is accompanied by a statistical significance analysis. If the discovered miRNA modules are closely related, the target mRNAs corresponding the miRNAs might reflect their functional relevance. The analysis using target genes can be biologically significant because miRNAs determine the target gene functions in a specific biological context. We examined significant terms with p-value<0.01 for the module I, hsa-miR-147 and hsa-miR-296. The results are shown in Table III. Among common target genes of two miRNAs, 13 genes (BCL3, BCL6, CCND1, CCND2, CDH1, DDX6, ETV6, FGFR1, MYCL1, IRF4, NF2, NRAS, and PDGFB) are annotated in a significant level. Overall, the target genes in the module I belong to characteristic functional categories, which are related to transcription, protein binding, regulation of cellular, physiological or biological process. Also, these are all related to cancer progression.

TABLE III
GO TERMS WERE EXTRACTED FOR THE mRNAS IN MODULE I.
OVERREPRESENTED TERMS WERE CHOSEN BY
HYPERGEOMETRIC TESTING AND MULTIPLE TESTING
ADJUSTMENT USING THE FALSE DISCOVERY RATE (FDR)
PROCEDURE (p < 0.01). *ADJUSTED p-VALUE
BY FDR.

| GO ID | Term | Ontology | *p-value | Genes |
|---|---|---|---|---|
| GO:0050794 | Regulation of cellular | BP | 2.63E−18 | BCL3, |
| | physiological process | | | BCL6, |
| GO:0050789 | Regulation of | BP | 6.43E−18 | CCND1, |
| | physiological process | | | CCND2, |
| GO:0005634 | Nucleus | CC | 1.52E−17 | CDH1, |
| GO:0065007 | Biological regulation | BP | 1.60E−16 | DDX6, |
| GO:0031323 | Regulation of cellular | BP | 3.73E−16 | ETV6, |
| | metabolic process | | | FGFR1, |
| GO:0045449 | Regulation of | BP | 3.91E−16 | MYCL1, |
| | transcription | | | IRF4, |
| | | | | NF2, |
| GO:0005515 | Protein binding | MF | 4.36E−16 | NRAS, |
| GO:0019219 | Nucleobase, nucleotide | BP | 7.22E−16 | PDGFB |
| | and nucleic acid | | | |
| | metabolism | | | |

Table IV describes the miRNA module I in detail. It shows the chromosomal location information of the module I, and functional description of their shared putative target mRNAs, which are annotated GO terms with p<0.01.

TABLE IV
DESCRIPTION OF THE miRNAs AND THEIR TARGET mRNAs
COMPRISING MODULE I

| miRNA | Chr. | Start-End Position | Strand |
|---|---|---|---|
| hsa-miR-147 | Chr9 | 122047078-122047149 | — |
| hsa-miR-296 | Chr20 | 56826065-56826144 | — |

| Target | |
|---|---|
| mRNA | Description |
| BCL3 | B-Cell Leukemia/Lymphoma-3 |
| BCL6 | B-Cell Lymphoma-6 (zinc finger protein 51) |
| CCND1 | Cyclin D1 |
| CCND2 | G1/S-specific cyclin D2 |
| CDH1 | cadherin 1, type 1, E-cadherin (epithelial) |
| DDX6 | DEAD(Asp-Glu-Ala-Asp) box polypeptide 6 |
| ETV6 | ets variant gene 6 (TEL oncogene) |
| FGFR1 | fibroblast growth factor receptor 1, |
| | fms-related tyrosine kinase 2, Pfeiffer syndrome |
| IRF4 | interferon regulatory factor 4 |
| MYCL1 | v-myc myelocytomatosis viral oncogene homolog 1, |
| | lung carcinoma derived (avian) |
| NF2 | neurofibromin 2 (bilateral acoustic neuroma) |
| NRAS | neuroblastoma RAS viral oncogene homolog |
| PDGFB | platelet-derived growth factor beta polypeptide, |
| | (simian sarcoma viral (v-sis) oncogene homolog) |

As is stated above, hsa-miR-147 is located at 9q.22 with high frequency of LOH, and the sequence of hsa-miR-296 maps to human chromosome 20. All annotated target genes are actively involved in tumorigenesis. For instance, BCL3 is inducible by DNA damage and is required for the suppression of persistent p53 activity which regulates the cell cycle and hence functions as a tumor suppressor [26. D. Kashatus, P. Cogswell, and A. S. Baldwin, Expression of the Bcl-3 proto-oncogene suppresses p53 activation, Genes and Development, 20, pp. 225-235, 2006.]. The human proto-oncogene BCL6 suppresses the expression of the p53 tumor suppressor gene and modulates DNA damage-induced apoptotic responses in germinal-centre B cells [27. R. T. Phan and R. Dalla-Favera, The BCL6 proto-oncogene suppresses p53 expression in germinal-centre B cells, Nature, 432(7017), pp. 635-639, 2004.]. Thus, altered expressions of BCL3 and BCL6 lead to tumorigenic potential and it is functionally essential for cancer growth and survival. As a result, we conclude that the hypernetwork classifiers find cancer-related miRNA modules, which apparently interact with each other.

V. Conclusions

We propose a method for detecting gene modules from microarray data using hypernetwork classifiers. An evolutionary approach is designed to find the best hypernetworks without exhaustive search in limited resources.

The proposed method is applied to the miRNA expression profiles on multiple human cancers. The experimental results show that the hypernetwork classifiers outperform decision trees and naive Bayes, while providing comparable performance to neural networks and support vector machines.

It also shows that the hypernetwork classifiers find biologically significant miRNA blocks. The hypernetwork structures are effective since it provides interpretable solutions, as well as producing good classification performance. Future study includes the analysis of the order-effect in hypernetworks and a more detailed analysis of the gene modules discovered.

The embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A method for identifying gene modules from microarray data using the hypernetwork including vertices and weighted hyperedges, comprising:
building the hypernetwork classifier from microarray data using a random hypernetwork process;
performing evolution of the hypernetwork as generation goes on; and
using the evolved hypernetwork classifier for microarray data analysis to discover gene modules.

2. The method of claim 1, wherein the procedure for building the hypernetwork classifier comprising:
starting with the empty hypernetwork H′=(X′,E′,W′)=(Ø,Ø,Ø);
getting a training sample x with the probability p and generating the hypernetwork H′=(X′,E′,W′), which includes hyperedges (individuals), Eᵢ, of cardinality k from x by a random hypergraph process;
being H←H∪H′; and
going to the getting step unless the termination condition is met.

3. The method of claim 2, wherein the evolutionary algorithm to adjust the weights of the hyperedges in hypernetwork classifier comprising:
getting a training example (x, y), after generating a population by the random hypernetwork process;
evaluating the fitness by classifying x, which let this class be y*;
updating the population if y*≠y, which c_{Ei}←c_{Ei}+Δc_{Ei}, where c_{Ei} is the number of individuals corresponding the hyperedge Eᵢ∈E(x, y) and normalizes the duplicates of all individuals for the current population; and
going to the getting step unless the termination condition is met.

4. The method of claim 1, wherein the microarray data is microRNA (miRNA) expression data.

5. The method of claim 4, further comprising: finding the functional correlations among miRNA target genes by extracting the gene ontology terms, to examine the discovered miRNAs.

6. The method of claim 3, wherein the gene modules are associated with cancer when the microarray includes cancer-related samples.

7. The method of claim 6, wherein the hypernetwork is the 2-uniform hypernetwork to classify the miRNA expression profiles.

8. The method of claim 7, wherein the microarray data uses a set of data (x, y), where x=(x₁, x₂, . . . ,xₙ)∈{0, 1}ⁿ and y∈{0,1}.

9. The method of claim 8, wherein individuals of the hypernetwork classifier are selected from the training samples with the probability p=0.5.

10. The method of claim 7, wherein a sigmoid function is using as the energy function of the hypernetwork classifier.

11. The method of claim 8, wherein there are used the expression profiles of 151 miRNAs on 89 samples, which consists of 68 multiple human cancer tissues and 21 normal tissues.
